(19) United States
(12) Patent Application Publication
(10) Pub. No.: US 2011/0072355 A1
(43) Pub. Date: Mar. 24, 2011

(54) AT-A-DISTANCE MAGIC LENSES FOR PRIVACY-SENSITIVE, COLLABORATIVE DOCUMENT VIEWING ACROSS MOBILE DEVICES AND LARGE DISPLAYS

(75) Inventors: Scott Carter, Los Altos, CA (US); Laurent Denoue, Palo Alto, CA (US); Chunyuan Liao, Mountain View, CA (US)

(73) Assignee: FUJI XEROX CO., LTD., Tokyo (JP)

(21) Appl. No.: 12/566,539

(22) Filed: Sep. 24, 2009

(51) Int. Cl. G06F 3/048; G06F 15/16; G06Q 40/00; G06K 9/00

(52) U.S. Cl. 715/738; 709/203; 705/39; 382/118

(57) ABSTRACT

Systems and Methods that allows multiple users to see a privacy-filtered overview of a document on a large display and that allows them to view on their personal mobile device details of the same document that are specific to their credentials.

### BACKGROUND OF THE INVENTION

1. Field of the Invention

This invention relates in general to methods and systems for enabling privacy-sensitive, collaborative document viewing across mobile devices and large displays.

2. Description of the Related Art

While large displays are increasingly ubiquitous, because they are inherently public they are inappropriate for applications that display privacy-sensitive data. Thus, many applications running on public displays tend to minimize private details. When used in tandem, mobile devices and public displays can provide a clean separation of public and private information. Yet much of the past work that couples mobile devices and public displays has focused on the use of the mobile device as an input mechanism.

There has been certain work performed to distribute private information related to content visualized on public displays across different channels. Eaddy et al. (My Own Private Kiosk: Privacy-Preserving Public Displays. ISWC'04 pp. 132-135) developed a system that shows public information on a large display, tracks their current focus with a head-mounted eye-tracker, and “whispers” private information to them related to content they are currently viewing. Shoemaker and Inkpen (Single Display Privacyware: developed a system that uses special glasses that shutter at intervals synchronized with a public display to present personalized views. Greenberg et al. (PDAs and Shared Public Displays: Making Personal Information Public and Public Information Personal, Personal Technologies 3(1), 1999) developed a system that allows users to create and edit personal notes on PDAs, share personal notes with a public display, view, edit and create notes on the public display, and save a record of all notes on their PDA. Berger et al. (Using Symbiotic Displays to View Sensitive Information in Public, PerCom '05 pp.139-148) created a system that blurs private information from emails when it is presented on a large display. Blurred words in this system can be made available on a small display. Similarly, Sharp et al. (Secure Mobile Computing Via Public Terminals, Pervasive '06 p. 238-253) describes a system that censors data from single documents on a public display, with private details available on the mobile device.

However, the aforesaid approaches are fundamentally single user and do not make users in the group aware of the general activities of the other people interacting with the display.

### SUMMARY OF THE INVENTION

In accordance with an aspect of the inventive methodology, there is presented a system and method that allows users to collaborate around a privacy-filtered overview of a document on a large screen while accessing personal or private information on their mobile device. To accomplish this, the inventive system adapts the magic lens approach. A magic lens is an interactor that reveals more details within a user-controllable viewport on a graphical interface. Common in desktop applications, they have also recently been used in mashups of mobile devices and large display systems and paper documents. However, these approaches lack important context, such as who is using the device and their relationship to the document, where it is being used, and so on. Furthermore, they tend to require that the device itself function as the magic lens. Aspects of the inventive approach extend traditional approaches to encapsulate context to present multiple customized views. Aspects of the inventive system also allow users to control the lens at-a-distance using a representation of their viewport onscreen and sending location updates via a network.

Aspects of the present invention include a computer implemented system which includes a public display displaying filtered content based on filtering parameters, a receiving unit receiving instructions from multiple user devices, and a processing unit processing the instructions from the multiple user devices. The instructions may include receiving, from a corresponding user device, a location within the public display, displaying on the public display an indication indicating an area corresponding to the location received from the corresponding user device, unfiltering the filtered content within an area corresponding to the location; and transmitting the unfiltered content to the corresponding user device.

Aspects of the present invention include a method for utilizing a public display for collaborative content distribution. The method may include displaying filtered content on a public display based on filter parameters, receiving instructions from multiple user devices, and processing the instructions from the multiple user devices. The instructions may include receiving, from a corresponding user device, a location within the public display, displaying on the public display an indication indicating an area corresponding to the location received from the corresponding user device, unfiltering the filtered content within an area corresponding to the location, and transmitting the unfiltered content to the corresponding user device.

Aspects of the present invention further include a document retrieval system, which includes a public display displaying a plurality of thumbnails, each thumbnail representing a document, a receiving unit receiving instructions from multiple user devices, and a processing unit processing the instructions from the multiple user devices. The instructions may include receiving, from a corresponding user device, a location within the public display, displaying on the public display an indication indicating the location received from the corresponding user device, and transmitting, to the corresponding user device, the document corresponding to the thumbnail at the received location. The corresponding user device may be operable to navigate the indication on the public display, and real-time activity of all multiple user devices connected to the system may be displayed on the public display in real-time.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an embodiment of the invention in conjunction with a privacy filtered document on the public display.

FIG. 2 illustrates an embodiment of the invention in conjunction with a heatmap visualization showing accumulated interest areas over time for many users.

FIG. 3 illustrates an embodiment of the invention utilizing the viewport to represent high-level activity.

FIG. 4 illustrates an example of the document dataflow.

FIG. 5 illustrates an example functional diagram of the inventive system.

FIG. 6 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

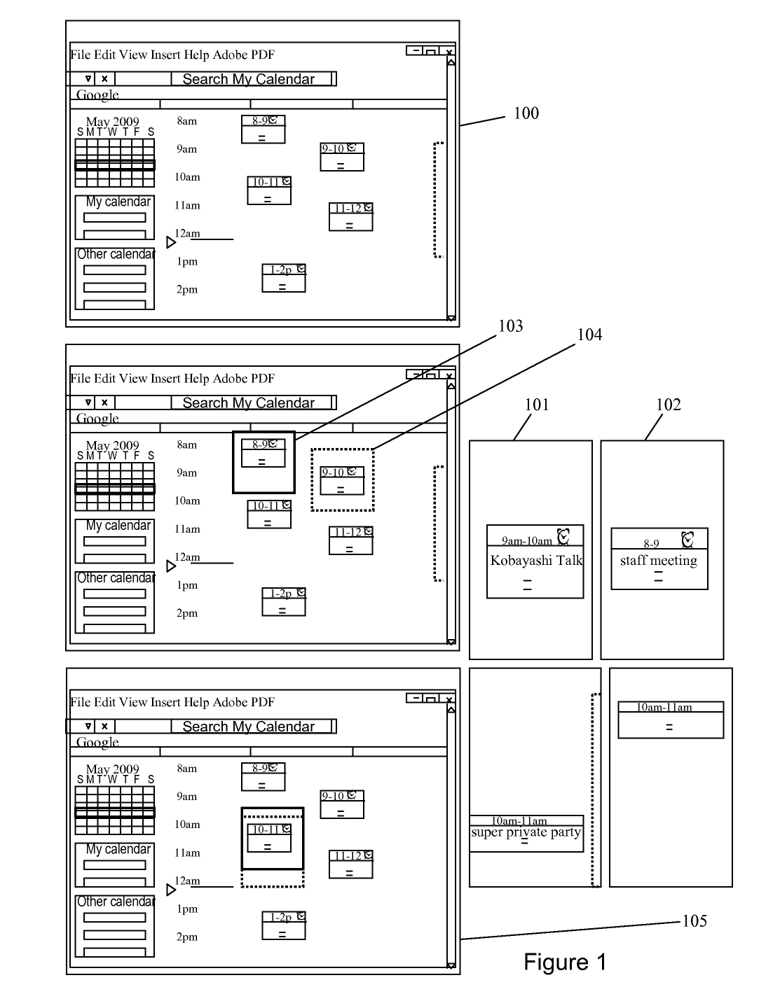

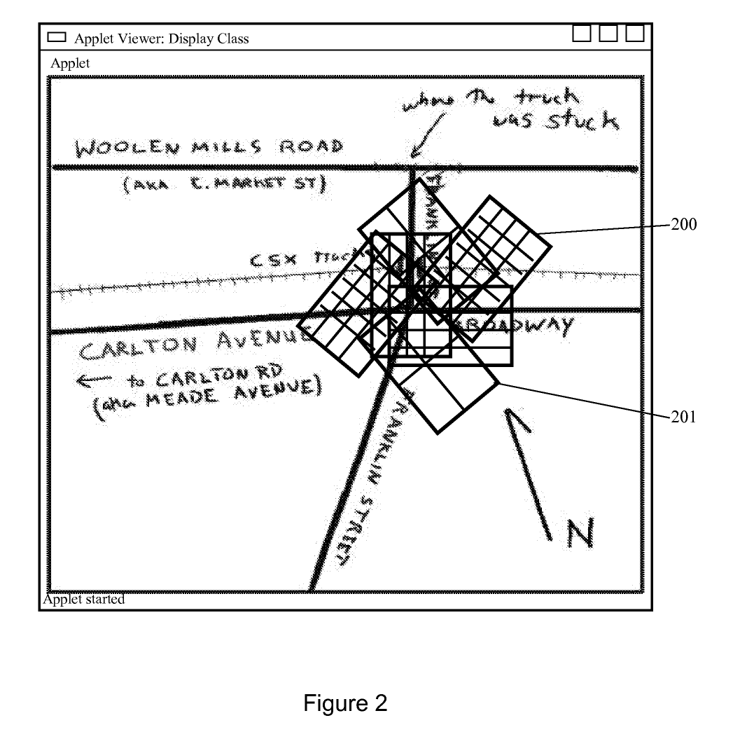

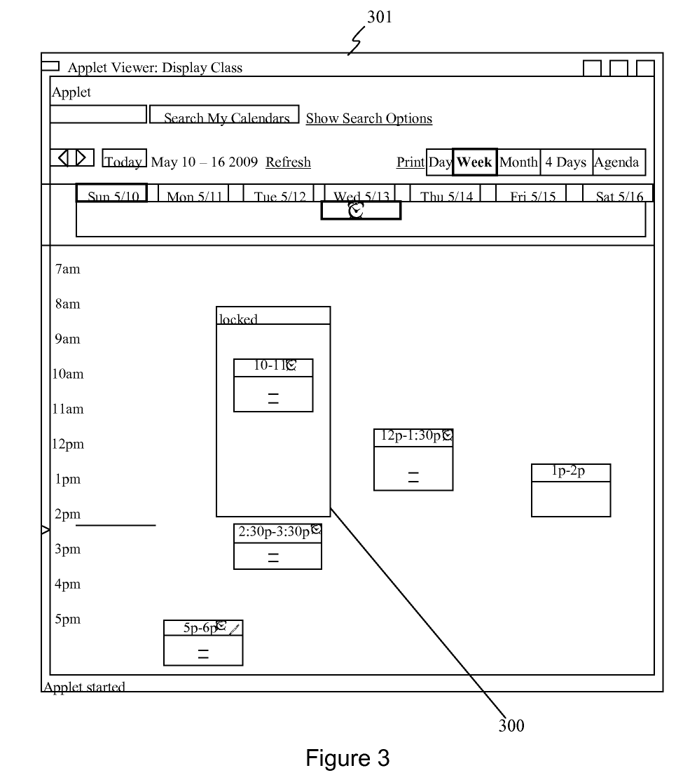

In accordance to one aspect of the inventive concept, the system involves a server platform executing a server application that drives a public display and that accepts socket connections from any number of instances of a mobile application. The mobile application provides a simple document viewer that sends pan and zoom updates to the server over the socket connection. The server uses these updates to render a representation of the viewport of each device on top of the document (see FIG. 1). A viewport can render in many different ways to support peripheral awareness in collaboration tasks. Specifically, in accordance with an embodiment of the inventive concept, the viewport may be configured to have the capability to: 1) be invisible 2) show only the current location of the user in the document 3) show the general activity that the user is taking with respect to the document (FIG. 3) or 5) show aggregate use over time (FIG. 2). Documents can reside on the server and in this case could be selectable via the mobile application. Alternatively, the mobile application can forward documents to the server over the socket connection.

The system in accordance with one embodiment of the invention further includes a component for rendering views of each document depending on the user identification, the relationship of the user with the document, and privacy attributes of the document itself. In most cases, the aforesaid relationships would be defined manually by the user, but in some cases some relationships can be inferred automatically, for example when a document owner shares a document with a colleague. Privacy attributes can also be defined manually, however automated approaches can also be widely used. For example, the server can send uploaded photos to a face-detection service and can blur detected areas in the large display representation of the photos. The system can also filter out important data types such as email addresses, social security numbers, etc.

The system in accordance with one embodiment of the invention is capable of performing the filtering on images to be displayed on the large display, for example by hooking into the display driver. It can also filter by intercepting API calls at the OS level, e.g. drawString in Windows. It can also perform its actions by means of specific plugins built for applications such as Microsoft Office or Web browsers like Firefox or Internet Explorer. For example, when a web page is shown on the large display, the system could automatically filter out email addresses shown in any web page, by leveraging the Document Object Model of that page. Similarly, the system could automatically filter out social security numbers shown in an Excel spreadsheet. In a document, the system would filter out numbers, addresses, etc.

In accordance with one embodiment of the inventive concept, the system is setup as a service for showing common document types onto the large display. The aforesaid document types may include, without limitation, Office documents, URLs, images, videos and the like. In one usage scenario, the document to be displayed is loaded into an instrumented version of a document viewer appropriate for showing this document type. For example, when a URL is requested, the inventive service loads the requested URL into a web browser, which was extended with an extension to filter out certain common entities described above (e.g. email addresses).

Furthermore, the filtering process on the large display can vary based on context, such as the location of the display and the level of activity surrounding the display.

The approach of one embodiment of the present invention utilizes at-a-distance magic lenses to allow multiple users to see a privacy-filtered overview of a document on a large display as well as a personalized view on their mobile device. The personalized view can be configured to show details available only to a subset of users, and may be generated on a display driver level, the OS level or application level. Privacy-filtering can be configured either manually or can also involve automatic approaches including face detection or keyphrase recognition. Filters may include entities such as email addresses, addresses, social security numbers or phone numbers, and so forth. The filtering approach on the large display can change based on context, such as the context of the display in regards to its surroundings and the like. Visualization of each magic lens on the large display can reveal either no information, the real-time activity of the user, or aggregate user activity.

In one embodiment of the invention, the content shown to the user on the user's individual display device is based on the access privileges of the user with respect to particular content. To determine access privileges of the user, the level of access of the user is first determined based on credentials of the user received from the corresponding user device and the permissions associated with the specific information that could be displayed on the personal display of the user. As would be appreciated by persons of skill in the art, the user's credentials may take any known or later developed form, including, for example, passwords, certificates, identity information, as the like. The received credentials of the user are then compared with the access privileges of the information. If the received credentials are sufficient to access the aforesaid information, the information is displayed to the user. The information displayed on the corresponding user device display is thus based on the determined level of access and permission information associate with the information displayed.

### IMPLEMENTATION EXAMPLES

In a first example, a graduate student wants to organize her weekly meeting with her adviser. She walks up to a large display, opens the mobile application on her device, and on the first screen selects the identification of the screen she is in front of in order to interact with it. She sees a list of documents she can view, and selects her advisor's calendar. The calendar now appears on the large display, showing blocked-out regions of time but no details. On her mobile device, she can scroll around to view details of the school-related entries, but she cannot see the details of all of the regions. She eventually finds a time that will work and that will not coincide with a meeting she knows is likely to overrun, and she adds a meeting request to the calendar. While she does so, the public display shows that time period as locked (FIG. 3). Later, the adviser brings up the same view but can see all of the details on her mobile device.

In a second example, two salesmen have just arrived in Copenhagen for a meeting. Some of their coworkers have already been in the city for a few days and have taken some pictures of sites to explore. Getting off the train, they find a large display and use their mobile application to select a map tool. Now a map of the city appears on the public display, while on their mobile phones they can see geotagged notes and photos overlaid on the map that were left by the other members of their team. One of the two salesmen can also see geotagged photos that he took on his last trip to Copenhagen, reminding him of good places to eat. Based on a heatmap visualization of others' interests (FIG. 2), they decide to look at an outdoor gallery in Nyhavn recommended to them by their colleagues before checking in at their hotel.

In a third example, friends gather in a bar and want to decide what song to play next on the stereo system. They all send their music collection items to the large display, and each person uses her mobile phone to navigate the space of songs arranged by genre. As each person navigates, the public display only shows how many people gravitated around a particular song, not their identity. A heatmap of popular choices tells people which song is most likely to please most people.

In a fourth example, government workers are having difficulty finding a specific graph in a 2347 page draft document that he needs to review for a special committee on simplifying congressional documents. They find a public display and squirt the file over. The display shows only low resolution thumbnails of the pages of the document. Using controls on their mobile devices, they navigate through the document, viewing the document on the large display to get a general sense for where each of them are. When they do, one of them then focuses on the mobile display, which shows the document in full resolution, to find the graph that is needed.

In a fifth example, a news broadcaster places a large public display in a crowded area. Sensors sense the number of people near the large public display at a given time. Depending on the number of people in proximity to the public display, various headlines are displayed on the public display, with options for purchasing an article. Interested bystanders see the headlines and connect to the system through their mobile devices. Each of them navigates their respective magic lens to the headline they are interested in, and submits a payment through the payment processor. The system accepts the payment, and transmits the respective article to the respective mobile devices.

FIG. 1 illustrates an embodiment of the invention in conjunction with a privacy filtered document on the public display. In this example, a privacy-filtered document (embodied as a calendar) is displayed on the large display 100. Two mobile devices connect to the large display: one (101) operated by the document owner and another (102) operated by a work colleague. The positions of their respective mobile viewports 103, 104 are visible on the large display. The aforesaid two users (owner and colleague) can use their respective mobile devices to view more details than are available to other users on the large display. In this case, because both users are viewing work-related entries, both users can see entry details. However, in the bottom example 105, both devices are viewing a personal entry, which is only available to the document owner.

FIG. 2 illustrates an embodiment of the invention in conjunction with a heatmap visualization showing accumulated interest areas over time for many users. This is represented here by heavily gridded areas 200 and lightly gridded areas 201 as an example. Other visualizations are also possible to represent the interest accumulated in sections of the display over periods of time; the grid representation is merely an example.

FIG. 3 illustrates an embodiment of the invention utilizing the viewport to represent high-level activity, which can indicate to people viewing the display screen 301 what other users are doing in the system. In this example, the user is locking a section of the document 300 for editing. Other actions being done by the user may also be displayed as well, such as viewing, uploading, downloading, etc., depending on the context and the configuration of the system.

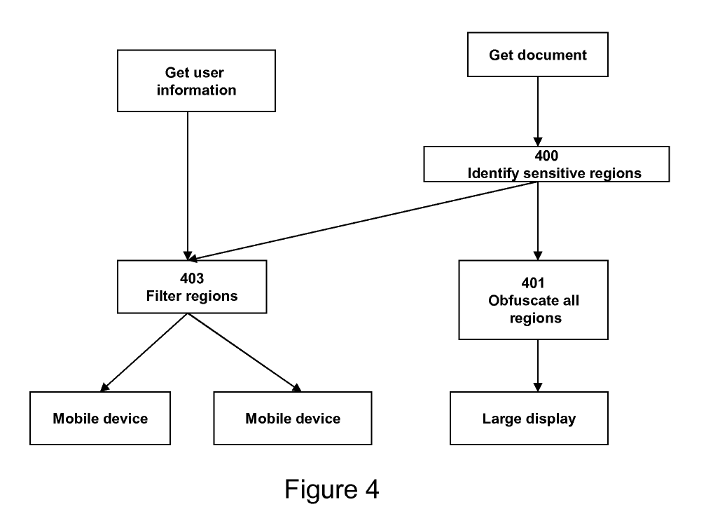

FIG. 4 illustrates an example of the document dataflow. First, for a given document, privacy-sensitive regions within the document are identified 400. A version of the document with all of the privacy sensitive regions obfuscated 401 is then sent to the public display. Versions of documents filtered according to each user's credentials and personal information are sent to each mobile device 403. The versions of documents sent to the user's will allow the users to view the unfiltered versions of the privacy sensitive regions based upon the credentials received.

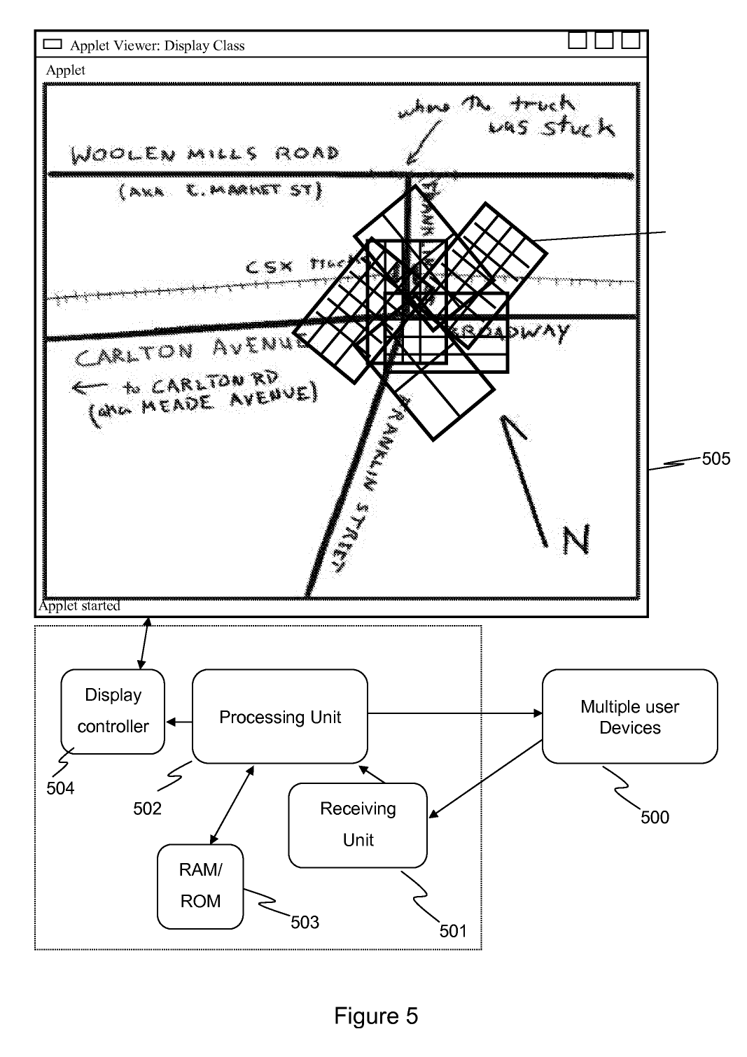

FIG. 5 illustrates an example functional diagram of the inventive system. In this example, the multiple user devices 500 engage the system by forwarding instructions to the receiving unit 501. The receiving unit then forwards the instructions to the processing unit 502, which processes the instructions and executes processes for the large display 505. The processing unit may utilize a display controller 504 and RAM/ROM 503 to accomplish the execution of the processes.

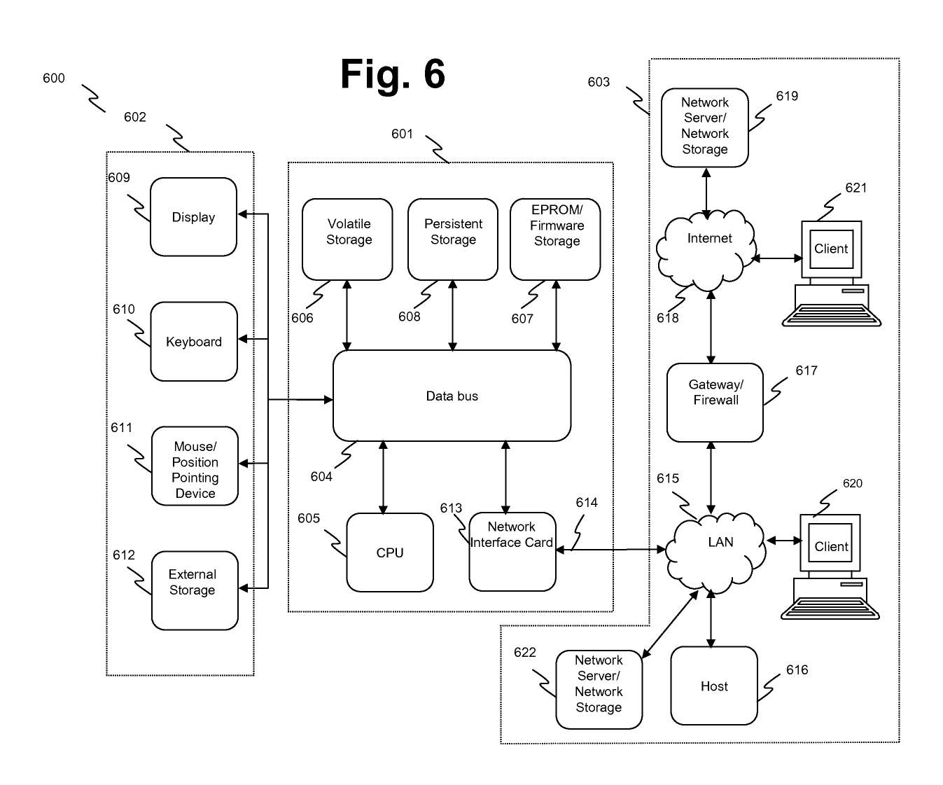

FIG. 6 illustrates an exemplary embodiment of a computer platform upon which the inventive system may be implemented.

FIG. 6 is a block diagram that illustrates an embodiment of a computer/server system 600 upon which an embodiment of the inventive methodology may be implemented. The system 600 includes a computer/server platform 601, peripheral devices 602 and network resources 603.

The computer platform 601 may include a data bus 605 or other communication mechanism for communicating information across and among various parts of the computer platform 601, and a processor 605 coupled with bus 601 for processing information and performing other computational and control tasks. Computer platform 601 also includes a volatile storage 606, such as a random access memory (RAM) or other dynamic storage device, coupled to bus 605 for storing various information as well as instructions to be executed by processor 605. The volatile storage 606 also may be used for storing temporary variables or other intermediate information during execution of instructions by processor 605. Computer platform 601 may further include a read only memory (ROM or EPROM) 607 or other static storage device coupled to bus 605 for storing static information and instructions for processor 605, such as basic input-output system (BIOS), as well as various system configuration parameters. A persistent storage device 608, such as a magnetic disk, optical disk, or solid-state flash memory device is provided and coupled to bus 601 for storing information and instructions.

Computer platform 601 may be coupled via bus 605 to a display 609, such as a cathode ray tube (CRT), plasma display, or a liquid crystal display (LCD), for displaying information to a system administrator or user of the computer platform 601. An input device 610, including alphanumeric and other keys, is coupled to bus 601 for communicating information and command selections to processor 605. Another type of user input device is cursor control device 611, such as a mouse, a trackball, or cursor direction keys for communicating direction information and command selections to processor 605 and for controlling cursor movement on display 609. This input device typically has two degrees of freedom in two axes, a first axis (e.g., x) and a second axis (e.g., y), that allows the device to specify positions in a plane.

An external storage device 612 may be coupled to the computer platform 601 via bus 605 to provide an extra or removable storage capacity for the computer platform 601. In an embodiment of the computer system 600, the external removable storage device 612 may be used to facilitate exchange of data with other computer systems.

The invention is related to the use of computer system 600 for implementing the techniques described herein. In an embodiment, the inventive system may reside on a machine such as computer platform 601. According to one embodiment of the invention, the techniques described herein are performed by computer system 600 in response to processor 605 executing one or more sequences of one or more instructions contained in the volatile memory 606. Such instructions may be read into volatile memory 606 from another computer-readable medium, such as persistent storage device 608. Execution of the sequences of instructions contained in the volatile memory 606 causes processor 605 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 605 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as storage device 608. Volatile media includes dynamic memory, such as volatile storage 606.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 605 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infra-red transmitter to convert the data to an infra-red signal. An infra-red detector can receive the data carried in the infra-red signal and appropriate circuitry can place the data on the data bus 605. The bus 605 carries the data to the volatile storage 606, from which processor 605 retrieves and executes the instructions. The instructions received by the volatile memory 606 may optionally be stored on persistent storage device 608 either before or after execution by processor 605. The instructions may also be downloaded into the computer platform 601 via Internet using a variety of network data communication protocols well known in the art.

The computer platform 601 also includes a communication interface, such as network interface card 613 coupled to the data bus 605. Communication interface 613 provides a two-way data communication coupling to a network link 615 that is coupled to a local network 615. For example, communication interface 613 may be an integrated services digital network (ISDN) card or a modem to provide a data communication connection to a corresponding type of telephone line. As another example, communication interface 613 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 613 sends and receives electrical, electromagnetic or optical signals that carry digital data streams representing various types of information.

Network link 613 typically provides data communication through one or more networks to other network resources. For example, network link 615 may provide a connection through local network 615 to a host computer 616, or a network storage/server 617. Additionally or alternatively, the network link 613 may connect through gateway/firewall 617 to the wide-area or global network 618, such as an Internet. Thus, the computer platform 601 can access network resources located anywhere on the Internet 618, such as a remote network storage/server 619. On the other hand, the computer platform 601 may also be accessed by clients located anywhere on the local area network 615 and/or the Internet 618. The network clients 620 and 621 may themselves be implemented based on the computer platform similar to the platform 601.

Local network 615 and the Internet 618 both use electrical, electromagnetic or optical signals that carry digital data streams. The signals through the various networks and the signals on network link 615 and through communication interface 613, which carry the digital data to and from computer platform 601, are exemplary forms of carrier waves transporting the information.

Computer platform 601 can send messages and receive data, including program code, through the variety of network(s) including Internet 618 and LAN 615, network link 615 and communication interface 613. In the Internet example, when the system 601 acts as a network server, it might transmit a requested code or data for an application program running on client(s) 620 and/or 621 through Internet 618, gateway/firewall 617, local area network 615 and communication interface 613. Similarly, it may receive code from other network resources.

The received code may be executed by processor 605 as it is received, and/or stored in persistent or volatile storage devices 608 and 606, respectively, or other non-volatile storage for later execution.

It should be noted that the present invention is not limited to any specific firewall system. The inventive policy-based content processing system may be used in any of the three firewall operating modes and specifically NAT, routed and transparent.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the system for enabling privacy-sensitive, collaborative document viewing across mobile devices and large displays. It is intended that the specification and examples be considered as exemplary only, with a true scope and spirit of the invention being indicated by the following claims.

What is claimed is:

1. A system comprising:
a public display displaying filtered content based on filtering parameters to multiple users;
a receiving unit operatively coupled to the public display and receiving instructions from multiple user devices, wherein each of the multiple user devices comprises a display; and
a processing unit coupled to the receiving unit for receiving from the receiving unit the instructions from multiple user devices and processing the received instructions from the multiple user devices; the instructions initiating a process comprising:
receiving, from a corresponding user device, a location within the public display;
displaying on the public display an indication indicating an area corresponding to the location received from the corresponding user device;
determining unfiltered content associated with the area corresponding to the location; and
displaying the determined unfiltered content on the display of the corresponding user device.

2. The system of claim 1, further comprising a sensor sensing presence of people in proximity to the public display and wherein the filtering parameters are adjusted based on a number of people in proximity to the public display.

3. The system of claim 1, wherein the determining unfiltered content further comprises determining a level of access based on credentials received from the corresponding user device, and wherein the displaying of the unfiltered content on the corresponding user device display is based on the determined level of access.

4. The system of claim 1, wherein the process further comprises:
receiving user content from the corresponding user device and a location on the public display;
receiving filter parameters and level of access for the user content;
filtering the user content based on the received filter parameters; and
displaying on the public display the filtered user content at the received location.

5. The system of claim 1, further comprising a payment processor; and
wherein the displaying the unfiltered content on the display of the corresponding user device occurs when the corresponding user device transmits payment information to the payment processor.

6. The system of claim 1, wherein the filtered content comprises a calendar and the unfiltered content comprises entries in the calendar.

7. The system of claim 1, wherein the public display further displays a heatmap visualization on the public display, the heatmap visualization representing accumulated interest over time of the locations in the public display.

8. The system of claim 1, wherein the indication further indicates real time activity of the corresponding user device.

9. The system of claim 1, wherein the indication further indicates aggregate user activity within the area.

10. A method for utilizing a public display for collaborative content distribution, the method comprising:
displaying filtered content on a public display based on filter parameters;
receiving instructions from multiple user devices, wherein each of the multiple user devices comprises a display; and
processing the instructions from the multiple user devices; the instructions initiating a process comprising:
receiving, from a corresponding user device, a location within the public display;
displaying on the public display an indication indicating an area corresponding to the location received from the corresponding user device;
determining unfiltered content associated with the area corresponding to the location; and
displaying the determined unfiltered content on the display of the corresponding user device.

11. The method of claim 10, further comprising:
sensing people in proximity to the public display; and
adjusting the parameters based on a number of people in proximity to the public display.

12. The method of claim 10, wherein the determining unfiltered content further comprises determining a level of access based on credentials received from the corresponding user device, and wherein the displaying the unfiltered content on the corresponding user device display is based on the determined level of access.

13. The method of claim 10, wherein the process further comprises:
receiving user content from the corresponding user device and a location on the public display;
receiving filter parameters and level of access for the user content;
filtering the user content based on the received filter parameters; and
displaying on the public display the filtered user content at the received location.

14. The method of claim 10, wherein the displaying the unfiltered content on the display of the corresponding user device occurs when the corresponding user device transmits payment to a payment processor.

15. The method of claim 10, wherein the filtered content comprises a calendar and the unfiltered content comprises entries in the calendar.

16. The method of claim 10, further comprising:
displaying a heatmap visualization on the public display, the heatmap visualization representing accumulated interest over time of the locations in the public display.

17. The method of claim 10, wherein the indication further indicates real time activity of the corresponding user device.

18. The method of claim 10, wherein the indication further indicates aggregate user activity within the area.

19. A document retrieval system comprising:
a public display displaying a plurality of thumbnails, each thumbnail representing a document;
a receiving unit receiving instructions from multiple user devices, wherein each of the multiple user devices comprises a display; and
a processing unit processing the instructions from the multiple user devices; the instructions initiating a process comprising:
receiving, from a corresponding user device, a location within the public display;
displaying on the public display an indication indicating an area corresponding to the location received from the corresponding user device; and
displaying in the corresponding user device display, the document corresponding to the thumbnail at the received location;
wherein the corresponding user device is operable to navigate the indication on the public display; and
wherein real-time activity of all multiple user devices connected to the system is displayed on the public display in real-time.

20. The document retrieval system of claim 19, further comprising face recognition sensors recognizing people in proximity to the public display and wherein the processing unit selects which thumbnails to display on the public display based on facial recognition information received from the face recognition sensors.
